(19) United States
(12) Patent Application Publication
(10) Pub. No.: US 2004/0172931 A1
(43) Pub. Date: Sep. 9, 2004

(54) Cutting device for plants

(75) Inventors: Walter Kolb, Betzdorf (DE); Michael Simon, Mittelhof (DE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: WOLF-Gerate AG

(21) Appl. No.: 10/630,011

(22) Filed: Jul. 30, 2003

(30) Foreign Application Priority Data
Jul. 31, 2002 (DE) 102 34 814.6

(51) Int. Cl. A01D 34/53

(52) U.S. Cl. 56/249

(57) ABSTRACT

A cutting device for plants, particularly lawnmower, is provided with at least one rotating blade (4a), which cooperates with a stationary counter-blade (13a). Here, at least the blade (4a) and/or the counter-blade (13a) is replaceably arranged in a respective blade support (3a, 14a).

### BACKGROUND OF THE INVENTION

The invention relates to a cutting device for plants, particularly a lawnmower, with at least one rotating blade, which cooperates with a stationary counter-blade, wherein the blade is curved and arranged obliquely around the rotation axis.

Such cutting systems are known as spiral-bladed mowers. Their main advantage consists in that the counter-blade ensures a clean cut. Thereby a lower rotation speed for the rotating blade is sufficient, and the danger of accident by objects hurled out by centrifugal force is markedly reduced.

A certain disadvantage of the known cutting systems with counter-blades consists in their expensive production, because the blades are arranged in spiral form around the rotation axis. This blade geometry also makes the re-sharpening of the blades more expensive, because a special machine is necessary for this.

For this reason, operation is predominantly with cutting systems according to the so-called sickle principle. Here, the blade does not rotate about a horizontal rotation axis as in spiral-bladed mowers, but instead about a vertical rotation axis. Because there is no counter-blade, it must operate at higher rotational speed. This brings about, on the one hand, a loud noise emission and, on the other hand, increased danger of accident from objects hurled out by centrifugal force. Moreover, the lawn cut is not as clean, because of the omitted counter-blade.

A lawnmower with the features of the preamble of claim 1 has become known from European Patent EP 050 151 B1. There, the rotating blades consist of a plurality of elliptical disks, which are arranged parallel to each other at an angle of about 30° to 50° to their common rotation axis. The cutting edges of the rotating blades extend over the whole periphery of 360°. For this purpose, the disks of elliptical contour adjacent to the peripheral ends of the main shaft are provided with ears, which extend away from the cutting plane in opposite directions, so that they cooperate at an acute angle with the stationary counter-blade. The disks are of multilayer construction, namely with two hardened outer layers and an unhardened intermediate layer. Their rotation axis consists of a polygonal tube with radially-extending vanes which, on the one hand, act to stiffen the disks and, on the other hand, act to produce a fan effect.

This known blade construction entails a high production cost, can only be re-sharpened on special machines when the blades are worn, and tends to become clogged because of the large-surfaced, closed construction of the cutting disks.

### BRIEF SUMMARY OF THE INVENTION

The present invention has as its object to improve this known cutting system operating with a counter-blade, so that the production costs are markedly decreased and operation is improved. Furthermore, the maintenance of cutting ability, whether by re-sharpening or by blade replacement, is substantially facilitated.

This object is attained according to the invention in that at least one blade and/or the counter-blade is/are interchangeably arranged in a respective blade support.

The advantage results thereby that the blade or the counter-blade can be quickly and easily dismantled for re-sharpening, without the complete drive shaft having to be disassembled, as in the known case. Moreover, the isolated blades, which run level within a plane only over a short elliptical curve, can be reconditioned on conventional grinding machines, which is not possible in the known case.

A particularly easy replacement is made possible in that the blade and/or the counter-blade are held in their respective blade support, in particular in a slot thereof, by a latch or snap connection. The replacement can thereby optionally even be performed without tools. One skilled in the art has countless possibilities for the construction of this latch or snap connection. It is particularly favorable if the blade can be inserted in its assigned slot approximately perpendicular to the cutting edge, thus approximately radially in the case of the rotating blade, and thereupon arrested, in particular positively latched, in the slot by an approximately axial displacement.

In the case of the rotating blade, it is advisable to provide the drive shaft, which can be formed as a perforated member, with approximately axially running through slots, into which the blade supports can be pushed in succession. The drive shaft has plural slots successively in the peripheral direction, so that a plurality of individual blade supports follow one another in the peripheral direction and also in the axial direction.

In contrast to the known construction, the blades according to the invention extend only over a peripheral angle of at most 150°, preferably at most 100°, of an imaginary circular arc around the rotation axis, namely only over the slightly curved region of the elliptical contour. A high axial speed relative to the counter-blade results there, and thus a better cut. Furthermore, this isolation of the blades and the blade supports leads to a substantial reduction of the risk of clogging, since the blades together with their blade supports act as local fan blades, particularly when four or more successive blades are arranged in a radial plane of the rotation axis.

So that the obliquely placed blades do not lead to a one-sided heaping up of the cut grass on one side of the lawnmower, it is advisable not to arrange all the blades parallel to one another, but preferably to orient the blades at one end of the drive shaft oppositely in their oblique position to the axially adjacent blades, so that grass cut there is transported away from the end of the drive shaft.

Another expedient improvement of the invention consists in that the blade and/or the counter-blade is connected at its edge opposite the cutting edge with a guide element, and this guide element is arranged exchangeably in the blade support. The blade is thereby substantially easier to handle and also to mount. Furthermore, the possibility arises of producing the blade from a steel strip, particularly a spring steel strip, whereas its guide element and likewise the blade support are made of plastic. The blades together with their guide elements are thereby most cost-effectively produced.

Another expedient improvement of the invention consists in that the blade and/or the counter-blade are pre-tensioned relative to one another by spring elements. It is thereby ensured that the cutting elements are always kept in mutual contact independently of their wear, and indeed over the axial extent as well as over the periphery of the rotating blade. The springing expediently takes place, not unitarily via the drive shaft or the counter-blade, but individually for each individual blade or respectively for each individual segment of the counter-blade, which is divided into segments. It is particularly favorable here if the spring elements are arranged between the blade support, on the one hand, and the guide element of the blade and/or of the counter-blade, on the other hand, particularly if they are formed directly on the blade support and/or on the guide element, approximately in the form of elastic bending beams, spring tongues, or the like.

The already mentioned segmentation of the counter-blade can correspond to the division of the rotating blade in the axial direction, but a different division can also be considered throughout, particularly when the rotating blades significantly overlap in the axial direction.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

Further features and advantages of the invention will become apparent from the dependent claims and from the drawing and the following description of exemplary embodiments:

FIG. 1 is a perspective view showing the use of the cutting device according to the invention in a partially shown lawnmower;

FIG. 2 is a radial section in perspective view through a blade support with its blades;

FIG. 3 is a similar perspective view as in FIG. 2, but with complete blade illustration;

FIG. 4 is a plan view of a blade and its blade support;

FIG. 5 is a perspective view of the complete blade arrangement and the counter-blade;

FIG. 6 is a perspective view of the counter-blade;

FIG. 7 is a perspective view of an alternative constructional form of the blade support; and

FIG. 8 is a perspective view of the blade for the blade support according to FIG. 7.

### DETAILED DESCRIPTION OF THE INVENTION

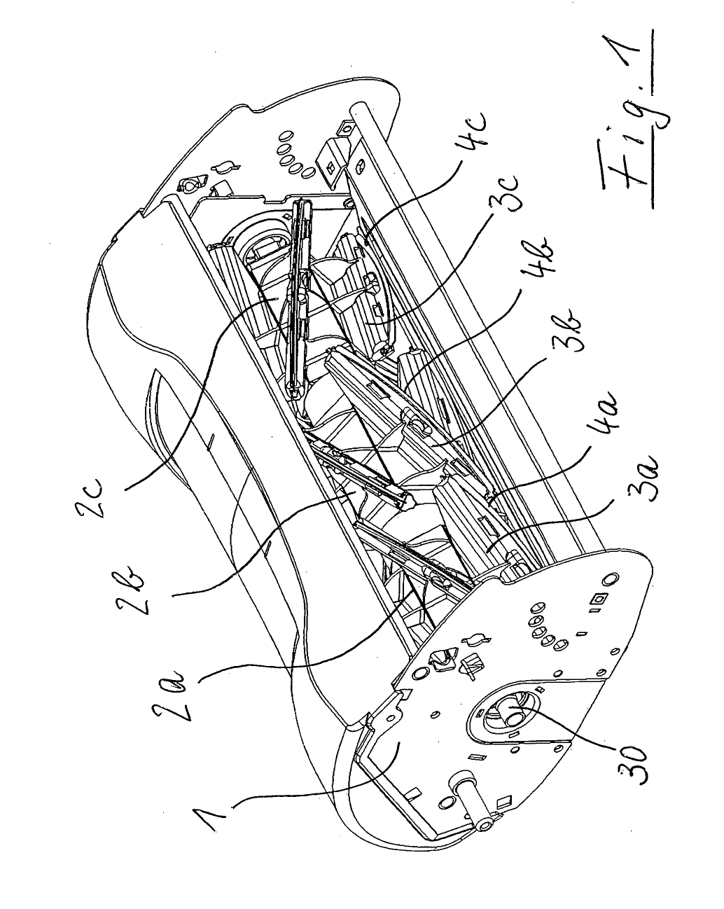

In FIG. 1 can be seen the cutting apparatus of a spiral-bladed lawnmower, installed in a housing 1; wherein for the sake of clarity, the chassis, the drive, the guide yoke, and other parts have been omitted from the Figure. In the housing 1 three successive hub members 2a, 2b, 2c are mounted axially one after another on a common drive shaft 30. The drive shaft 30 is conventionally driven by a motor or from the wheels of the lawnmower. Each hub member has on its outer periphery plural outwardly projecting blade supports 3a, 3b, 3c arranged in succession in the peripheral direction, which in turn support on their outer edge a respective blade 4a, 4b, 4c.

The blades 4a, 4b, 4c are not arranged in a spiral form around the shaft 30, but instead in planes oriented obliquely to the drive shaft, and the outer contour of the blade has an approximately elliptical shape.

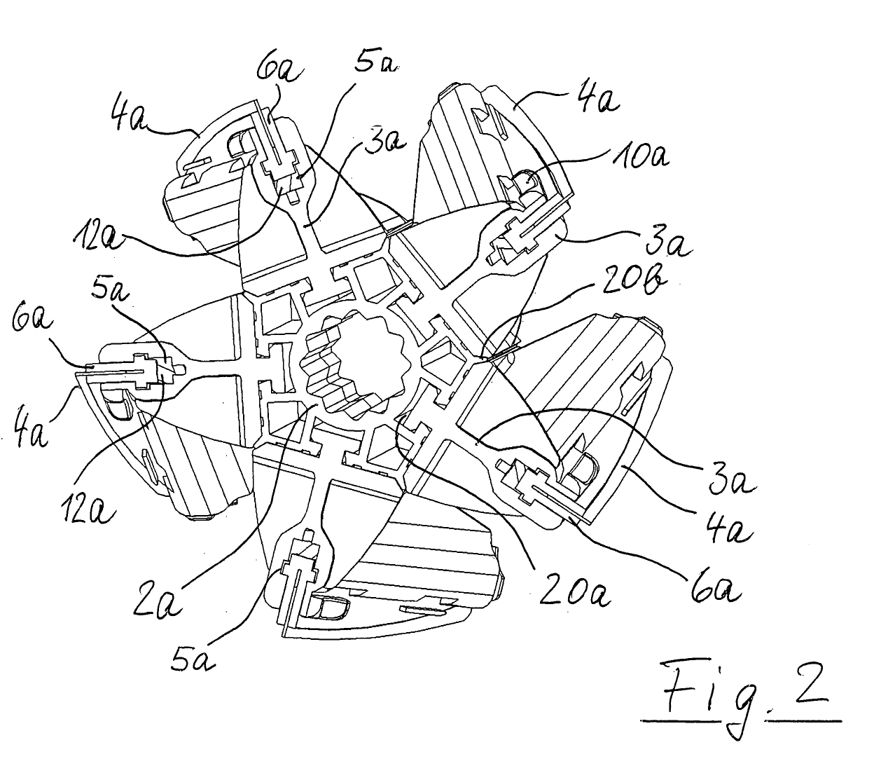

The construction of the blades and blade supports can be gathered in more detail from FIGS. 2-4. It can be seen there that the hub members have a polygonal cross section at their outer periphery, and that at least one slot 20a and guide surface 20b is arranged on each polygonal side, which serve to receive a blade support 3a, such that the blade support can be pushed in the axial direction onto the hub member 2a and be positively held in the peripheral direction and the radial direction. Locking it in the axial direction takes place either by building the hub member into the housing 1 or by a common shaft or by other known fastening means.

In this manner, each hub member supports plural blades in succession in the peripheral direction. The blades run, similarly to the blade supports, in a respective plane which forms an angle of about 20°-40° with the rotation axis. For reasons of simpler manufacture, this angle is the same for all blades and all hub members. However, the blades of one hub member can be oriented oppositely oblique to those of another hub member.

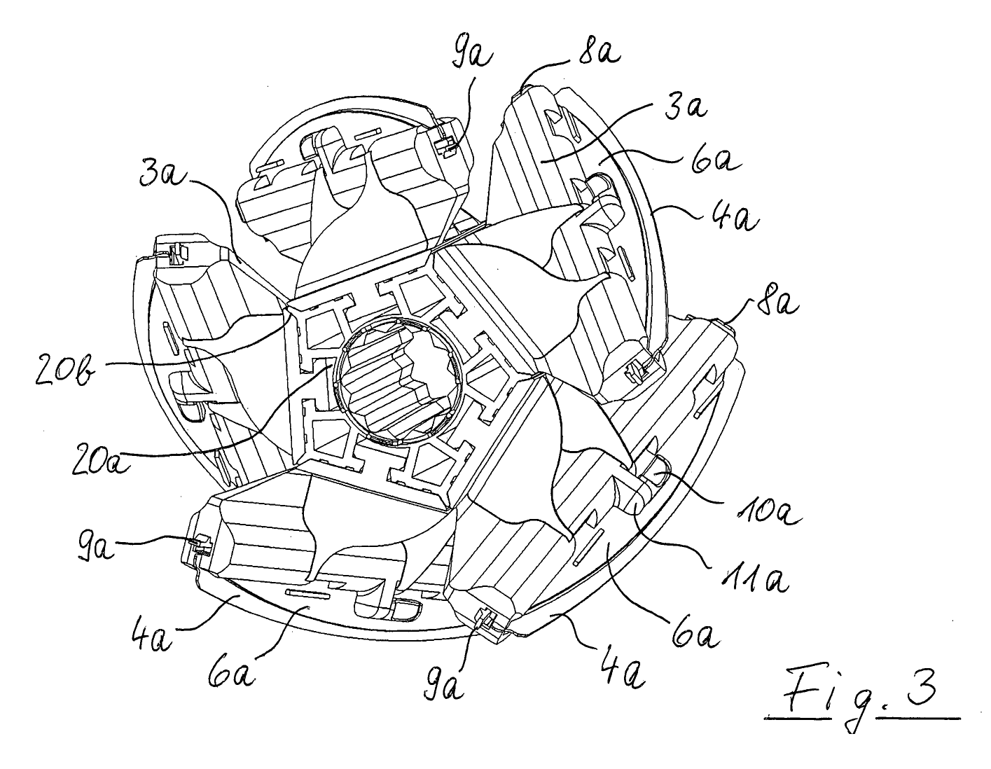

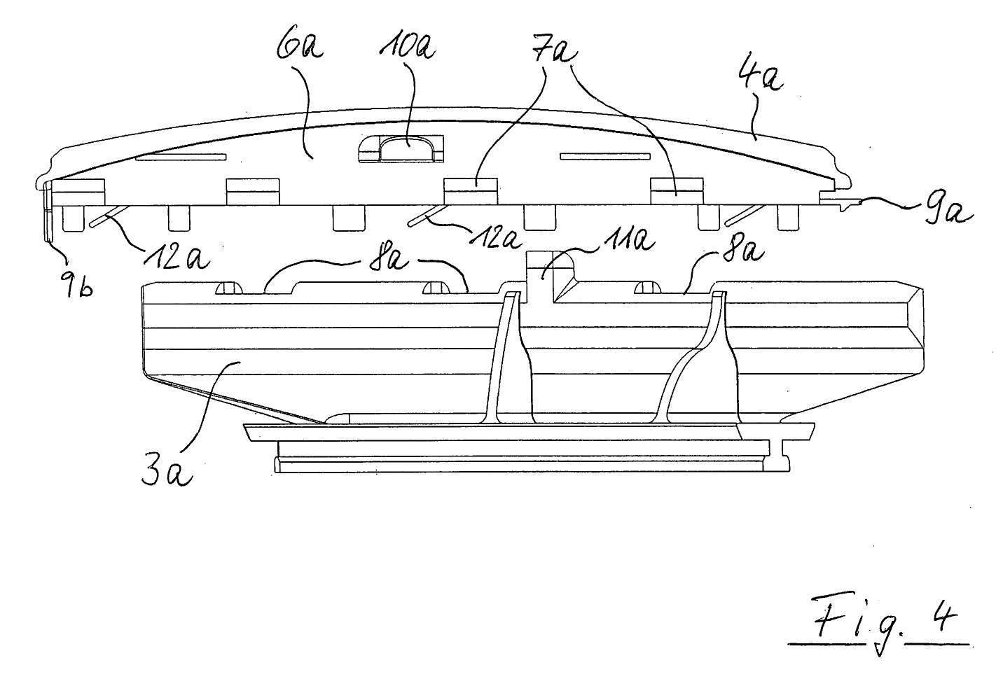

Since the blades undergo a certain amount of wear, they are mounted, according to the invention, to be easily replaceable in their respective blade supports. For this purpose, the blade supports have at their outer region a respective slot 5a passing through in the longitudinal direction, which receives the blade 4a, 4b, 4c pushed in axially and/or radially from outside. So that the blade 4a is held in the slot, it has on the blade back a guide element 6a, which in its turn (see FIG. 4) has projections 7a projecting transversely. These projections, upon a given longitudinal displacement of the blade with respect to its blade support, fit into corresponding recesses 8a of the blade support, so that the blade in this position can be inserted radially from outside into the slot 5a of the blade support. Then, the blade is displaced longitudinally, until its left-hand stop 9b strikes against the left-hand end of the blade support. In this position, a catch 9a arranged on the right-hand end of the guide element snaps into a corresponding recess of the blade support, so that the guide element of the blade is firmly locked in its blade support. This state can be seen in FIG. 3.

For easy insertion and displacement, the guide element has a small grip 10a on both sides. This grip can additionally abut on a stop 11a of the blade support when the guide element of the blade has latched into its final position.

It is moreover important that the blade is respectively mounted displaceably in approximately the radial direction on the blade support, preferably by its guide element. For this purpose the blade, or more precisely its guide element 6a, is provided with several spring elements 12a (see FIG. 4) projecting downwardly. These spring elements, formed as bending beams, are supported on the bottom of the slot 5a (see FIG. 2), when the blade is assembled, and press the blade outwardly. It is thereby ensured, independently of the wear condition of the blades, that they always come into contact with the counter-blade upon rotation.

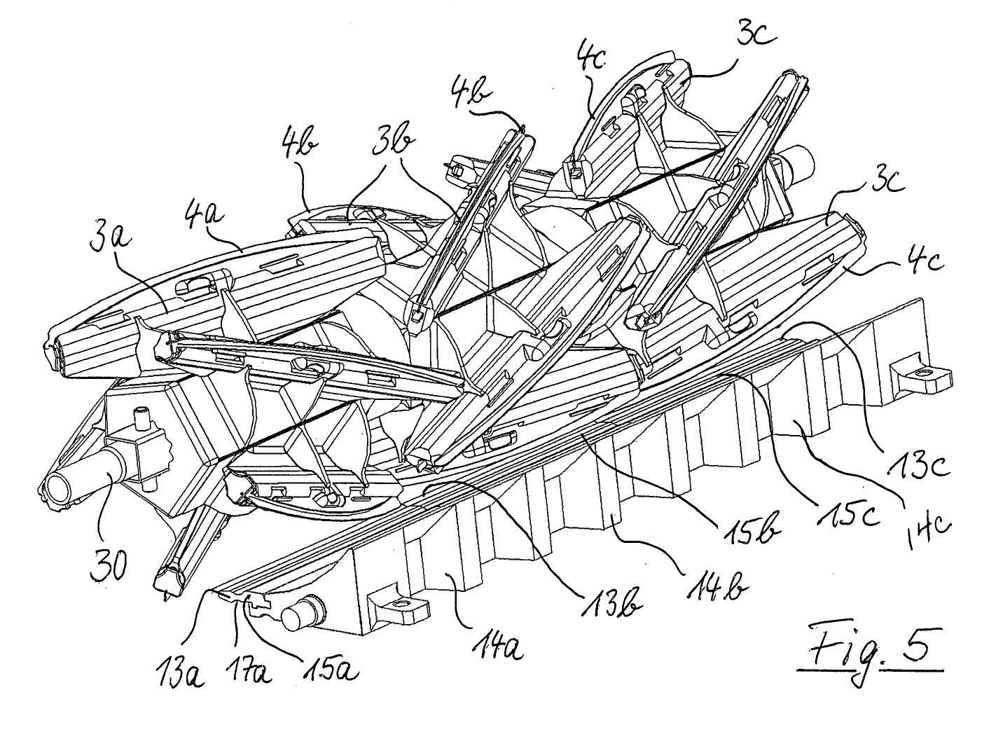

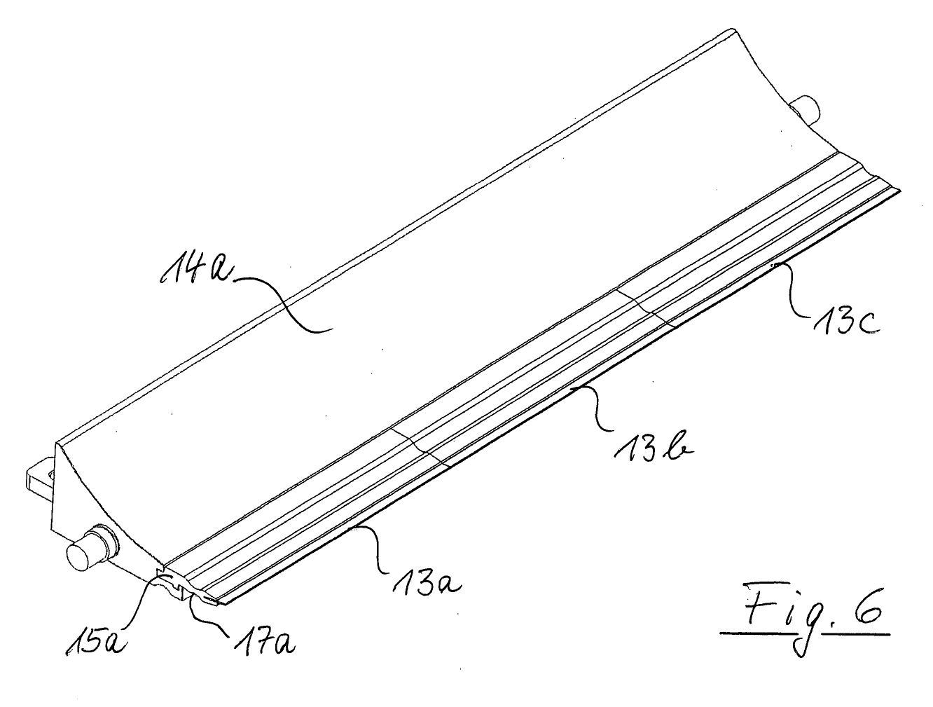

The counter-blade can be seen in FIGS. 5 and 6. It usually runs parallel to the rotation axis of the blade, but is divided into three segments 13a, 13b, 13c. It is important that these counter-blade segments also be clamped, for easy replacement, in a blade support 14a, 14b, 14c. This clamping is effected in that the counter-blade segments are angled multiple times at their base and can be inserted from above into a matching slot of the blade support. If the blade supports are then brought into contact with the rotating blades, they can no longer move upward and thus no longer come free out of their blade supports. The blade support 14a is shown segmented in FIG. 5; however, it can be in one piece throughout, as in FIG. 6.

As FIG. 6 furthermore shows, the counter-blade segments 13a, 13b, 13c are not plugged directly into their blade supports, but instead are firmly connected at their blade backs to guide elements 15a, 15b, 15c. These guide elements, just as with the rotating blades, are preferably made of plastic, which can be directly injection molded around the blades, expediently made of steel strip.

Finally it can be seen in FIGS. 5 and 6 that the guide elements 15a, 15b, 15c for the counter-blade segments have weakened cross sections in regions 17a extending in the longitudinal direction, so that they can yield a little in the transverse direction and so that the counter-blade segments can be elastically biased against the rotating blades. The regions 17a of weakened cross section thus function somewhat as spring elements.

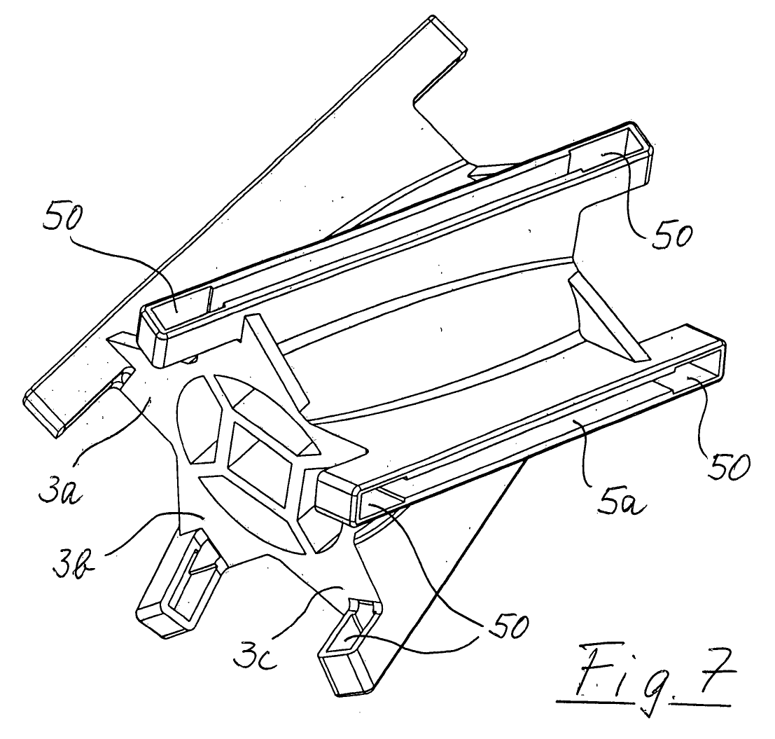

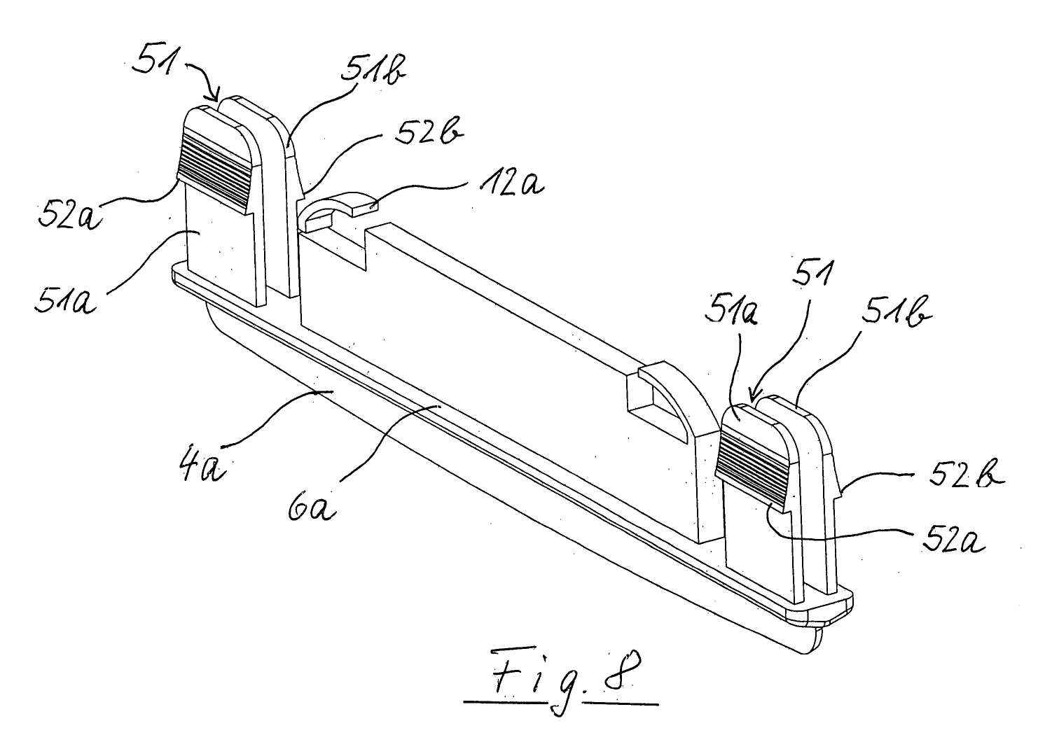

FIGS. 7 and 8 show an alternative construction form for the easily interchangeable connection between blade and blade support. First, the blade supports 3a, 3b, etc., are no longer separate from the hub member 2a as in the previously described construction, but instead are produced integrally with this. Further, the slots 5a in the blade supports for receiving the blades are formed differently, namely with regions 50 which are open on the side situated radially inwardly. In this embodiment, these inwardly-open slot regions 50 are situated on the two projecting ends of the slots 5a, because these regions are easily accessible. The blade supports could, however, also have recesses in the middle region, whereby the slot regions situated inwardly are accessible.

The reason for this special slot construction can be seen in FIG. 8. One can see there the associated blade 4a with its guide element 6a and the elastic spring tongues 12a. If this blade is inserted radially into the slot 5a of the blade support, the spring tongues 12a then abut on the floor of the slot 5a, as similarly shown in FIG. 2.

It is now important that the guide element 6a, preferably at its two ends, have latch elements 51 projecting approximately radially inwardly, which are positioned and dimensioned to match the slot regions 50 of the blade support, such that upon insertion of the blade in its slot 5a they latch in the slot region 50 or preferably on the end of the slot region lying rearwardly in the insertion direction.

According to FIG. 8, the latch elements 51 are respectively formed by two elastic fingers 5la and 51b, which are arranged spaced parallel to each other and have projections 52a, 52b on their outer sides. These projections are formed so that they are pressed together on insertion of the blade into its slot. When the insertion process has ended, the projections 52a and 52b will have passed through the slot regions 50 and can snap outwardly on the radially inwardly lying ends of the slot regions. The blade can thereby be positively fixed in the radial direction in the blade holder.

To release the blade, the fingers 51a and 51b only need to be pressed together at their projecting ends, so that they can be pushed outward again through the slot regions 50.

For the fixing of the blade in the longitudinal direction, the fingers 52a and 52b can likewise be relied on, in that these fingers abut on end closure walls of the slot 5a. Instead of this, however, other stop surfaces may also be considered.

Care still has to be taken, both in the construction form according to FIG. 4 and also in the construction form according to FIGS. 7 and 8, that the blades respectively have a certain amount of play for movement in the radial direction, so that the elastic pressing of the blades by the spring tongues 12a radially outwardly toward the counter-blade 13a can be effective.

Finally, it should be mentioned that the described interchangeable blade mounting in the blade support can be used not only with the blades shown in the embodiments, which are arranged in oblique planes around the rotation axis, but also equally well with such blades which are arranged in spiral form around the rotation axis.

In summary, the cutting device according to the invention is distinguished by easy replaceability both of the rotating blades and also of the counter-blade segments. Likewise, the spring pressing, particularly of the rotating blade, ensures high cutting quality.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A cutting device for plants comprising at least one rotating blade (4a) which cooperates with a stationary counter-blade (13a), the at least one rotating blade being curved and arranged in oblique planes or helical form around a rotation axis of the device, wherein the at least one rotating blade (4a) and/or the counter-blade (13a) is respectively replaceably arranged in a blade support (3a, 14a) and wherein the blade (4a) and/or the counter-blade (13a) is held by a latch or snap connection in its respective blade support (3a, 14a).

2. The cutting device according to claim 1, wherein the blade (4a) and/or the counter-blade (13a) is mounted in at least one slot (5a) of its respective blade support (3a, 14a).

3. The cutting device according to claim 1, wherein the blade (4a) is insertable approximately transversely to its longitudinal extent into at least one slot (5a) of its blade support (3a) and is then lockable in this slot by an approximately axial displacement.

4. The cutting device according to claim 1, wherein the blade (4a) is insertable approximately transversely to its longitudinal extent into at least one slot (5a) of its blade support (3a) and is lockable therein by elastic latching elements (51a, 51b).

5. The cutting device according to claim 2, wherein plural slots (5a) are provided in succession in a peripheral direction.

6. The cutting device according to claim 5, wherein plural slots (5a) run approximately axially.

7. The cutting device according to claim 1, wherein the blade supports (3a) are connectable to a drive shaft (30) by plug-in connections.

8. The cutting device according to claim 7, wherein the plug-in connections comprise axially running slots (20a)

9. The cutting device according to claim 1, wherein the blades (4a) extend only over a peripheral angle of at most 150° of an imaginary circular arc around the rotation axis.

10. The cutting device according to claim 9, wherein the peripheral angle is at most 100°.

11. The cutting device according to claim 1, wherein in a radial plane of the rotation axis more than two blades (4a) are arranged in succession in a peripheral direction.

12. The cutting device according to claim 11, wherein in a radial plane of the rotation axis more than three blades (4a) are arranged in succession in a peripheral direction.

13. The cutting device according to claim 1, wherein axially adjacent blades (4a, 4b, 4c) are oriented partially non-parallel, but oppositely to one another.

14. The cutting device according to claim 1, wherein the at least one blade (4a) and/or the counter-blade (13a) is connected, at its edge respectively situated opposite the cutting edge, to a guide element (6a, 15a), and this guide element (6a, 15a) is replaceably arranged in the blade support (3a, 14a).

15. The cutting device according to claim 14, wherein the guide element (6a) has latching elements, which positively latch to the blade support (3a).

16. The cutting device according to claim 15, wherein two latching elements are provided, respectively latching in opposite directions.

17. The cutting device according to claim 15, wherein the latching elements latch into slot regions (50a) of the blade support (3a), and in the latched state the latching elements partially project from the slot regions (50a).

18. The cutting device according to claim 15, wherein the latching elements comprise elastic fingers (51a, 51b).

19. The cutting device according to claim 14, wherein the guide element (6a, 15a) is made of plastic.

20. The cutting device according to claim 1, wherein the at least one blade (4a) and/or the counter-blade (13a) comprises a metal strip.

21. The cutting device according to claim 20, wherein the at least one blade (4a) and/or the counter-blade (13a) comprises a spring steel strip

22. The cutting device according to claim 19, wherein the at least one blade (4a, 13a) is injection molded around its blade back from the guide element (6a, 15a) made of plastic.

23. The cutting device according to claim 1, wherein the at least one blade (4a) and the counter-blade (13a) are relatively biased against each other by spring elements (12a).

24. The cutting device according to claim 23, wherein the spring elements (12a) for biasing the blade (4a) are arranged between the blade support (3a) and a guide element (6a).

25. The cutting device according to claim 24, wherein the spring elements (12a) are formed directly on the blade support (3a) and/or the guide element (6a).

26. The cutting device according to claim 1, wherein the counter-blade is divided into plural axially adjacent segments (13a, 13b, 13c).

27. The cutting device according to claim 26, wherein the counter-blade segments (13a, 13b, 13c) are respectively individually resiliently mounted.

28. The cutting device according to claim 1, wherein the at least one rotating blade (4a) is arranged in a plane having an angle of at most 45° with respect to the rotation axis.

29. The cutting device according to claim 28, wherein the angle is at most 35°.

30. The cutting device according to claim 1, wherein the device is a lawnmower.
